(19) United States
(12) Patent Application Publication
(10) Pub. No.: US 2026/0291593 A1
(43) Pub. Date: Sep. 24, 2026

(54) METHOD OF BEAM FAILURE RECOVERY APPLIED IN SIDELINK USER EQUIPMENTS AND CORRESPONDING SIDELINK USER EQUIPMENT

(71) Applicant: MEDIATEK Inc., Hsinchu City (TW)

(72) Inventors: Jing-Wei Chen, Hsinchu City (TW); Tao Chen, Beijing (CN)

(21) Appl. No.: 19/473,844

(22) PCT Filed: May 15, 2024
(86) PCT No.: PCT/CN2024/093360

§ 371 Date: Oct. 9, 2025

(30) Foreign Application Priority Data
May 15, 2023 (WO) PCT/CN2023/094213

(51) Int. Cl. H04B 7/06; H04L 1/1812

(52) U.S. Cl. CPC H04B 7/06964; H04L 1/1812

(57) ABSTRACT

A method of beam failure recovery applied in sidelink (SL) user equipments (UEs) is provided. The method includes the following steps. Beam failure instances are detected by a first SL UE. A beam failure recovery procedure is triggered by the first SL UE when a number of the beam failure instances is equal or larger than an instance threshold. Under the beam failure recovery procedure, a new candidate beam is identified by a second SL UE which is a peer SL UE of the first SL UE. Under the beam failure recovery procedure, the new candidate beam and a UE identifier of the second SL UE is reported to the first SL UE by the second SL UE. Under the beam failure recovery procedure, a response from the first SL UE is monitored by the second SL UE.

This application is the 35 U.S.C. § 371 national stage of PCT application PCT/CN 2024/093360, filed May 15, 2024, which claims the benefit of PCT application Serial No. PCT/CN 2023/094213, filed May 15, 2023, the disclosure of which is incorporated by reference herein in its entirety.

### TECHNICAL FIELD

The disclosure relates to a method of beam failure recovery applied in sidelink user equipments and corresponding sidelink user equipments.

### BACKGROUND

5G system is the fifth generation of mobile communication technology, representing a new generation of wireless communication technology aimed at providing faster data transmission speeds, lower latency, greater network capacity, and the ability to connect more devices.

Sidelink (SL) transmission in 5G system allows direct communication between two user equipments (UEs) without the need for relay through a base station. This direct device-to-device communication offers many advantages, including lower latency, higher data transfer rates, and better system capacity utilization.

To improve SL throughput for commercial applications (e.g., file transfer between smartphones, XR (Extended Reality) tethering between smartphone and wearable XR glasses), FR2 (frequency range 2) frequency band is preferred due to large transmission bandwidth and short transmission latency. It is necessary to overcome pathloss, reduce interference and improve coverage for beamformed transmission or reception on FR2 frequency band in SL transmission. With beam paired transmission link, a SL beam failure recovery procedure is required to recover a beam failure.

### SUMMARY OF THE INVENTION

According to one embodiment, a method of beam failure recovery applied in sidelink (SL) user equipments (UEs) is provided. The method includes the following steps. Beam failure instances are detected by a first SL UE. A beam failure recovery procedure is triggered by the first SL UE when a number of the beam failure instances is equal or larger than an instance threshold. Under the beam failure recovery procedure, a new candidate beam is identified by a second SL UE which is a peer SL UE of the first SL UE. Under the beam failure recovery procedure, the new candidate beam and a UE identifier of the second SL UE is reported to the first SL UE by the second SL UE. Under the beam failure recovery procedure, a response from the first SL UE is monitored by the second SL UE.

According to another embodiment, a sidelink (SL) user equipment (UE) for performing beam failure recovery is provided. The SL UE includes a communication module and a processing unit. The processing unit controls the communication module, and is configured to perform the following procedures: detecting beam failure instances; and triggering a beam failure recovery procedure when a number of the beam failure instances is equal or larger than an instance threshold. Under the beam failure recovery procedure, a peer SL UE identifies a new candidate beam. Under the beam failure recovery procedure, the peer SL UE reports the new candidate beam and a UE identifier of the peer SL UE to the SL UE. Under the beam failure recovery procedure, the peer SL UE monitors a response from the SL UE.

### BRIEF DESCRIPTION OF THE DRAWINGS

FIG. 1 illustrates the flowchart of a method of beam failure recovery applied in sidelink (SL) user equipments (UEs) according to an embodiment of the disclosure.

FIG. 2 illustrates a block diagram of a SL UE for performing beam failure recovery according to an embodiment of the disclosure.

FIG. 3 shows a PHY (Physical Layer) layer and a MAC (Media Access Control) layer of a SL UE according to an embodiment of the disclosure.

FIG. 4 illustrates the procedure that the second SL UE identifies the new candidate beam of the first SL UE according to an embodiment of the disclosure.

FIG. 5 illustrates another procedure that the second SL UE identifies the new candidate beam of the first SL UE according to an embodiment of the disclosure.

FIG. 6 shows an example of beam failure recovery applied in SL UEs according to an embodiment of the disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION OF EMBODIMENTS

The method of beam failure recovery applied in sidelink (SL) user equipments (UEs) and corresponding SL UEs according to an embodiment of the disclosure is related to enhanced sidelink operation on FR2 (Frequency Range 2) licensed spectrum RAN1 and RAN2. FR2 offers high data rates and low latency, making it ideal for applications requiring high-speed wireless connectivity.

Sidelink beam management often includes initial beam-pairing, beam maintenance, and beam failure recovery by reusing existing sidelink CSI (Channel State Information) framework and reusing Uu (user equipment and base station) beam management concepts wherever possible. Beam management in FR2 licensed spectrum considers sidelink unicast communication. SL on FR2 adopts beam-based operation.

SL baseline operation often includes sensing, resource selection, and transmission operations. In sensing operation, UE blind decodes all SCI (Sidelink Control Information) (SCI signal is a control information which would be monitored by all UEs) from other UE to collect reservation information. In resource selection operation, UE selects resources for transmission based on SCI sensing results. In transmission operation, UE transmits selected resources.

NR (New Radio) is the global standard developed by the 3rd Generation Partnership Project (3GPP) for 5G wireless communication. It's the foundation for the 5G mobile network infrastructure and devices. NR defines the specifications for how wireless devices communicate over the air interface (Uu interface between base station and UE), enabling high-speed data transmission, ultra-low latency, and massive connectivity, which are key characteristics of 5G technology.

Differences between NR system and SL system mainly include the follows. In NR system, when beam failure occurs and beam failure recovery is needed, UE can detect beam failure when the measured power (RSRP (Reference Signal Received Quality)) of SSB (single-side band) signal is smaller than a threshold, UE can trigger beam failure recovery and transmits the index of new beam to the base station through RACH (Random access control channel) signal. Then, the base station will update the beam pair between the base station and the UE. However, in SL system, SL has no RACH signal for informing new beam. SL has no roll definition like gNB and UE, and each UE have to proactively schedule transmission to its peer UE.

According to these differences, the beam failure detection (BFD) and beam failure recovery (BFR) procedures in NR system cannot be applied directly to SL system. Therefore, some aspects should be considered when designing beam failure detection and beam failure recovery procedures in SL system. These aspects include: which RS (Reference signal) or criteria can be used by UE for BFD; how does UE identify new candidate beam; how does UE recover beam (i.e. report or apply new candidate beam); and which one of TX (transmitter) UE or RX (receiver) UE can perform BFD or BFR.

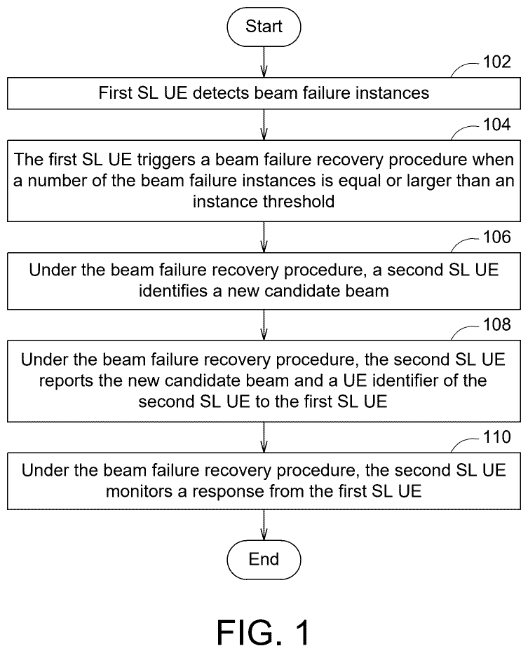

With the considerations above, referring to FIG. 1, the flowchart of a method of beam failure recovery applied in sidelink (SL) user equipments (UEs) according to an embodiment of the disclosure is illustrated. The method includes the following steps. In step 102, a first SL UE detects beam failure instances. Then, step 104 is entered, and the first SL UE triggers a beam failure recovery procedure when a number of the beam failure instances is equal or larger than an instance threshold. After that, step 106 is performed. In step 106, under the beam failure recovery procedure, a second SL UE identifies a new candidate beam. The second SL UE is a peer SL UE of the first SL UE. Then, step 108 is entered. In step 108, under the beam failure recovery procedure, the second SL UE reports the new candidate beam and a UE identifier of the second SL UE to the first SL UE. After that, in step 110, under the beam failure recovery procedure, the second SL UE monitors a response from the first SL UE.

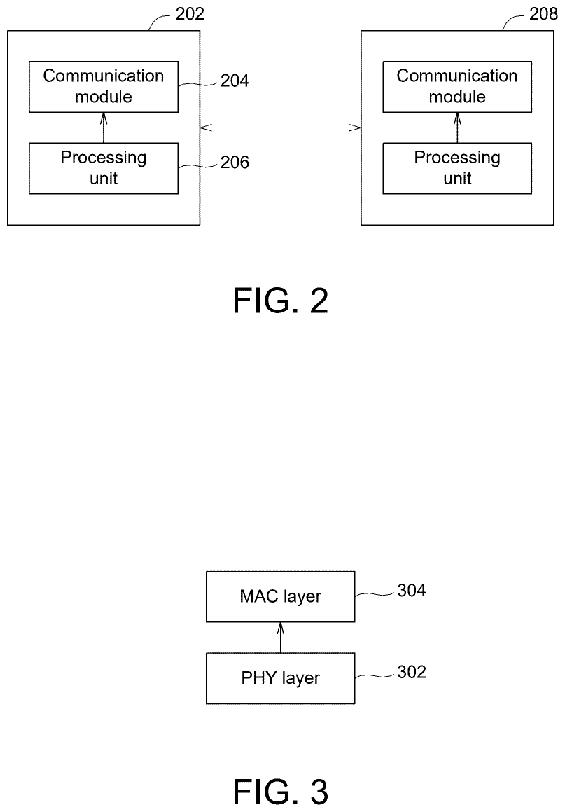

Referring to FIG. 2, a block diagram of a SL UE for performing beam failure recovery according to an embodiment of the disclosure is illustrated. The SL UE 202 includes a communication module 204 and a processing unit 206. The processing unit 206 controls the communication module 204. The processing unit 206 is configured to perform the following procedures. The processing unit 206 detects beam failure instances. The processing unit 206 triggers a beam failure recovery procedure when a number of the beam failure instances is equal or larger than an instance threshold. Under the beam failure recovery procedure, a peer SL UE 208 identifies a new candidate beam. Under the beam failure recovery procedure, the peer SL UE 208 reports the new candidate beam and a UE identifier of the peer SL UE 208 to the SL UE 202. Under the beam failure recovery procedure, the peer SL UE 208 monitors a response from the SL UE 202. The method and the SL UE will be explained in more detail as follows.

In step 102, the first SL UE 202 detects beam failure instances. Assume that a given sidelink pair is formed in two SL UEs, for example, the first SL UE 202 and the second SL UE 208. Step 102 may also be referred as the procedure of beam failure detection of sidelink. The first SL UE 202 may detect beam failure according to the signal transmitted from the second SL UE 208 to the first SL UE 202. For example, when NACK (Negative-Acknowledgment) signal is sent from the second SL UE 208 to the first SL UE 202, the first SL UE 202 can determine that beam failure occurs. Or, when the measured power or the RSRP (Reference Signal Received Quality) of the signal sent from the second SL UE 208 to the first SL UE 202 is lower than a threshold, the first SL UE 202 can determine that beam failure occurs. When the first SL UE 202 determines that beam failure occurs, the first SL UE 202 can increase the value of beam failure instances, for example, add value 1 to the value of beam failure instances, or increase the number of beam failure instances. In some embodiment, a counter can be used to count the number of the beam failure instances during a particular time interval set by a timer.

For example, when the first SL UE 202 receives a HARQ (Hybrid Automatic Repeat reQuest)-NACK signal from the second SL UE 208, the number of the beam failure instances BFI is increased, for example, increased by 1. Or, when a measured RSRP of a SL CSI-RS (Channel State Information-Reference Signal) received by the first SL UE 202 from the second SL UE 208 is lower than a RSRP threshold TH0, the number of the beam failure instances is increased, for example, increased by 1.

In some embodiment, the number of the beam failure instances is increased when at least one of the following conditions is met: the first SL UE 202 receives a HARQ-NACK from the second SL UE 208 after a PSCCH (Physical Sidelink Control Channel) or a PSSCH (Physical Sidelink Shared Channel) is sent to the second SL UE 208 by the firs SL UE 202; the first SL UE 202 receives no HARQ-ACK and no HARQ-NACK from the second SL UE 208 after the PSCCH or the PSSCH is sent to the second SL UE 208 by the firs SL UE 202 during a monitoring window (a time interval); a first RSRP of a periodic SL CSI-RS sent to the first SL UE 202 by the second SL UE 208 is lower than a first RSRP threshold TH1; and a second RSRP of a SL-SSB (S-SSB, which is SSB signal defined especially for SL) sent to the first SL UE 202 by the second SL UE 208 is lower than a second RSRP threshold TH2 when the S-SSB carries the UE identifier of the second SL UE 208.

In some embodiment, the number of the beam failure instances is increased when at least one of the following conditions is met: a third RSRP of a PSCCH or a PSSCH sent to the first SL UE 202 by the second SL UE 208 is lower than a third RSRP threshold TH3; a BLER (Block Error Rate) of the PSCCH or PSSCH sent to the first SL UE 202 by the second SL UE 208 is higher than a BLER threshold; a fourth RSRP of an aperiodic SL CSI-RS sent to the first SL UE 202 by the second SL UE 208 is lower than a fourth RSRP threshold TH4; and a fifth RSRP of a semi-persistence SL CSI-RS sent to the first SL UE 202 by the second SL UE 208 is lower than a fifth RSRP threshold TH5.

In step 104, the first SL UE 202 triggers a beam failure recovery procedure when a number of the beam failure instances is equal or larger than an instance threshold. In some embodiment, the number of the beam failure instances is calculated by a MAC (Media Access Control) layer of the first SL UE 202, and the beam failure recovery procedure is triggered by the MAC layer of the first SL UE 202.

Referring to FIG. 3, FIG. 3 shows a PHY (Physical Layer) layer and a MAC layer of a SL UE according to an embodiment of the disclosure. The PHY layer 302 of SL UE can provide a beam failure instance to the MAC layer 304 when one or more condition mentioned above is met. The MAC layer 304 counts the beam failure instances when a configured or pre-configured timer is not expired. The MAC layer 304 declares beam failure when the beam failure instance counter reaches a configured or pre-configured maximum number. The maximum number is configured or pre-configured differently when different condition(s) or mix condition(s) are used on PHY layer 302 to provide a beam failure instance. Once a beam failure is declared, the UE triggers a beam failure recovery procedure.

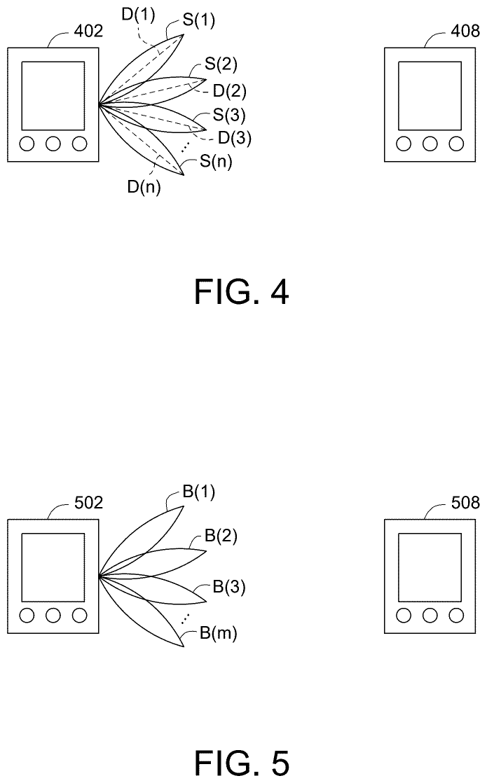

In step 106, under the beam failure recovery procedure, the second SL UE 208 identifies a new candidate beam. Referring to FIG. 4, FIG. 4 illustrates the procedure that the second SL UE identifies the new candidate beam of the first SL UE according to an embodiment of the disclosure. The second SL UE 408 can identify the new candidate beam of the first SL UE 402 by the following procedure. When the first SL UE 402 transmits a number of signals with different beam directions to the second SL UE 408, the second SL UE 408 measures the signals and identifies the new candidate beam corresponding to one of the signals having a particular beam direction with best RSRP.

For example, assume the signals S(1) to S(n) have beam directions D(1) to D(n), wherein n is an integer. The second SL UE 408 measures the signals S(1) to S(n) and identifies the new candidate beam corresponding to one of the signals S(1) to S(n). Assume the signal S(3) with the beam direction D(3) has best RSRP. Then, the second SL UE 408 can identify the new candidate beam as the beam corresponding to the signal S(3).

In some embodiment, the second SL UE 408 can identify the new candidate beam of the first SL UE by the following procedures. When the first SL UE 402 transmits a plurality of SL CSI-RS resources with different beam directions to the second SL UE 408, the second SL UE 408 measures the SL CSI-RS resources and identifies the new candidate beam corresponding to one of the SL CSI-RS resource with best RSRP. In some embodiment, the second SL UE 408 can identify the new candidate beam of the first SL UE 402 by the following procedures. When the first SL UE 402 transmits a plurality of S-SSB carrying a UE identifier of the first SL UE 402 to the second SL UE 408, the second SL UE 408 measures the plurality of S-SSB and identifies the new candidate beam corresponding to one of the S-SSB with best RSRP.

Referring to FIG. 5, FIG. 5 illustrates another procedure that the second SL UE identifies the new candidate beam of the first SL UE according to an embodiment of the disclosure. The first SL UE 502 triggers a beam pairing procedure toward the second SL UE 508 when the beam failure recovery procedure is triggered, and the second SL UE 508 identifies the new candidate beam of the first SL UE 502 under the beam pairing procedure. In the beam pairing procedure, the first SL UE 502 sequentially transmits the beams B(1) to B(m) to the second SL UE 508, and the second SL UE 508 selects one of beams B(1) to B(m) which has best RSRP and identifies the selected beam as the new candidate beam of the first SL UE 502.

In some embodiment, the second SL UE 508 identifies the new candidate beam of the first SL UE 502 by the following procedures. The first SL UE 502 triggers a beam pairing procedure which is similar to an initial beam pairing procedure when two SL UE start to discover each other and to be paired. In the beam pairing procedure, the first SL UE 502 transmits beam measuring reference resources or beam measuring reference signals with beam sweeping. The second SL UE 508 measures the beam measuring reference resources or the beam measuring reference signals sent from the first SL UE 502 and identifies the new candidate beam corresponding to one of the beam measuring reference resources with best RSRP or one of the beam measuring reference signals with best RSRP. For example, the first SL UE 502 sequentially transmits beam measuring reference resources or beam measuring reference signals corresponding to beams B(1) to B(m) with beam sweeping, wherein m is an integer. The second SL UE 508 selects the beam measuring reference resource with best RSRP or the beam measuring reference signal with best RSRP. Assume the beam measuring reference resource corresponding to beam B(3) or the beam measuring reference signal corresponding to beam B(3) is selected. Then, the second SL UE 508 identifies the beam B(3) as the new candidate beam.

In some embodiment, when beam failure recovery is triggered by the SL UE, the SL UE identifies new candidate beam(s) of the peer UE by one or more following solution(s). When a periodic SL CSI-RS is configured or pre-configured to be transmitted by the peer UE during a configured or pre-configured SL beam recovery interval, the SL UE measures SL CSI-RS resources and identifies new candidate beam(s) with best RSRP(s). When an aperiodic or semi-persistence SL CSI-RS is transmitted by the peer UE during a configured or pre-configured SL beam recovery interval, the SL UE measures the aperiodic or semi-persistence SL CSI-RS resources and identifies new candidate beam(s) with best RSRP(s). When S-SSB carries UE identifier and S-SSB is transmitted by the peer SL UE during a configured or pre-configured SL beam recovery interval, the SL UE measures S-SSB and identifies new candidate beam(s) with best RSRP(s).

In some embodiment, UE triggers beam pairing procedure during a configured or pre-configured SL beam recovery interval with following steps. Through beam pairing procedure, a new candidate beam can be identified. In step 1, UE transmits beam measuring reference resources with beam sweeping. The beam failure detection result (e.g., failure beam ID (identifier), RSRP) and/or the peer UE's identifier are carried through SCI and/or MAC CE (control element) (MAC CE is a header in MAC packet along with transmitted data). In step 2, the peer UE detects beam pairing requirement and reference resources from UE. The peer UE measures reference resources from the UE and identify new candidate beam(s). The beam pairing procedure's methodology is similar to SL initial beam pairing procedure, except that the contents carried for initial beam pairing procedure (e.g., DCR (Direct Communication Request) message) is replaced by beam failure information in the beam pairing procedure for identifying new candidate beam(s).

In step 108, under the beam failure recovery procedure, the second SL UE reports the new candidate beam and the UE identifier of the second SL UE to the first SL UE. The second SL UE reports the new candidate beam and the UE identifier of the second SL UE to the first SL UE through a SCI (Sidelink Control Information) signal, for example.

In step 110, under the beam failure recovery procedure, the second SL UE monitors a response from the first SL UE. The first SL UE sends the response to the second SL UE on a PSFCH (Physical Sidelink Feedback CHannel), for example, corresponding to a PSCCH or a PSSCH of the second SL UE.

In some embodiment, after UE identifies new candidate beam(s), the UE informs the peer UE with new candidate beam(s) and/or its own UE identifier, for example, through SL beam failure recovery request (BFRQ). UE reports new candidate beam(s) and/or its identifier through SCI to the peer UE with new paired best beam(s). Or, UE reports new candidate beam(s) and/or its identifier through MAC CE to the peer UE with new paired best beam(s). Or, UE informs its peer UE the new candidate beam(s) and its own identifier through PSFCH corresponding to the PSSCH carrying reference resources transmitted by the peer UE.

Once the UE informs the peer UE with new candidate beam(s) and/or its identifier (e.g., BFRQ), the UE will monitor for a response from the peer UE, for example, through SL beam failure recovery response (BFRR), during a configured or pre-configured monitoring interval. The response from the peer UE is sent through SCI or MAC CE or PSFCH corresponding to the PSSCH that carried SL BFRQ.

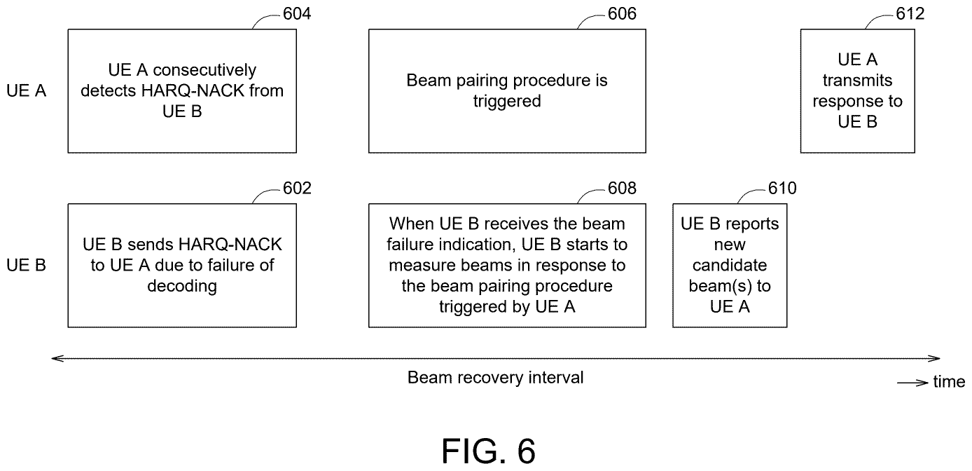

Referring to FIG. 6, FIG. 6 shows an example of beam failure recovery applied in SL UEs according to an embodiment of the disclosure. The timeline of this example is illustrated in FIG. 6. In this example, UE A and UE B are paired with unicast transmission. UE A transmits packet to UE B. The periodic SL CSI-RS resource is not configured. In step 1, as shown in blocks 602 and 604, UE B sends HARQ-NACK to UE A due to failure of decoding and UE A consecutively detects HARQ-NACK from UE B. UE A sends a beam failure instance(s) to MAC layer when a HARQ-NACK is received from UE B.

In step 2, MAC layer starts a beam failure counter and timer. Before the expiration of timer, MAC layer counts the beam failure instance by using the counter. In step 3, once the counter reaches the maximum value that is preconfigured corresponding to HARQ-NACK beam failure instance condition, the MAC layer of UE A triggers beam failure recovery procedure. For example, beam pairing procedure is triggered by UE A as shown in block 606.

In step 4, after UE A triggers beam pairing procedure during beam recovery timing window, UE A transmits reference resource(s) with multiple beams. The beam pairing procedure is similar to SL initial beam pairing procedure. The beam failure indication and identifier of UE B are carried in the transmitted resource(s) replacing DCR message in the SL initial beam pairing procedure.

In step 5, when UE B receives the beam failure indication, UE B starts to measure beams in response to the beam pairing procedure triggered by UE A, as shown in block 608. In step 6, UE B reports new candidate beam(s) to UE A, as shown in block 610. The report of UE B has similar container as SL initial beam pairing procedure. In step 7, UE A transmits response to UE B in similar container of SL initial beam pairing procedure, as shown in block 612.

The method of beam failure recovery applied in sidelink (SL) user equipments (UEs) and corresponding SL UE according to an embodiment of the disclosure can efficiently detect beam failures and execute beam failure recovery when beam failures occur. Therefore, connection stability is enhanced, communication efficiency is improved, and the fault tolerance of 5G sidelink systems is increased. These can also contribute to enhancing the user's communication experience and further advancing the application and development of 5G technology.

It will be apparent to those skilled in the art that various modifications and variations can be made to the disclosed embodiments. It is intended that the specification and examples be considered as exemplars only, with a true scope of the disclosure being indicated by the following claims and their equivalents.

1. A method of beam failure recovery applied in sidelink (SL) user equipments (UEs), comprising:
detecting beam failure instances by a first SL UE;
triggering a beam failure recovery procedure by the first SL UE when a number of the beam failure instances is equal or larger than an instance threshold;
under the beam failure recovery procedure, identifying a new candidate beam by a second SL UE which is a peer SL UE of the first SL UE;
under the beam failure recovery procedure, reporting the new candidate beam and a UE identifier of the second SL UE to the first SL UE by the second SL UE; and
under the beam failure recovery procedure, monitoring a response from the first SL UE by the second SL UE.

2. The method according to claim 1, wherein when the first SL UE receives a HARQ (Hybrid Automatic Repeat reQuest)-NACK (Negative-Acknowledgment) signal from the second SL UE, the number of the beam failure instances is increased;
wherein when a measured RSRP (Reference Signal Received Quality) of a SL CSI-RS (Channel State Information-Reference Signal) is lower than a RSRP threshold, the number of the beam failure instances is increased.

3. The method according to claim 1, wherein the first SL UE triggers a beam pairing procedure toward the second SL UE when the beam failure recovery procedure is triggered, and the second SL UE identifies the new candidate beam of the first SL UE under the beam pairing procedure.

4. The method according to claim 1, wherein the second SL UE reports the new candidate beam and the UE identifier of the second SL UE to the first SL UE through a SCI (Sidelink Control Information) signal, the number of the beam failure instances is calculated by a MAC (Media Access Control) layer of the first SL UE, and the beam failure recovery procedure is triggered by the MAC layer of the first SL UE.

5. The method according to claim 1, wherein the first SL UE sends the response to the second SL UE on a PSFCH (Physical Sidelink Feedback CHannel) corresponding to a PSCCH (Physical Sidelink Control Channel) or a PSSCH (Physical Sidelink Shared Channel) of the second SL UE.

6. The method according to claim 1, wherein the number of the beam failure instances is increased when at least one of the following conditions is met:
the first SL UE receives a HARQ-NACK from the second SL UE after a PSCCH or a PSSCH is sent to the second SL UE by the firs SL UE;
the first SL UE receives no HARQ-ACK and no HARQ-NACK from the second SL UE after the PSCCH or the PSSCH is sent to the second SL UE by the firs SL UE during a monitoring window;
a first RSRP of a periodic SL CSI-RS sent to the first SL UE by the second SL UE is lower than a first RSRP threshold; and
a second RSRP of a SL-SSB (S-SSB) sent to the first SL UE by the second SL UE is lower than a second RSRP threshold when the S-SSB carries the UE identifier of the second SL UE.

7. The method according to claim 1, wherein the number of the beam failure instances is increased when at least one of the following conditions is met:
a third RSRP of a PSCCH or a PSSCH sent to the first SL UE by the second SL UE is lower than a third RSRP threshold;
a BLER of the PSCCH or PSSCH sent to the first SL UE by the second SL UE is higher than a BLER threshold;
a fourth RSRP of an aperiodic SL CSI-RS sent to the first SL UE by the second SL UE is lower than a fourth RSRP threshold; and
a fifth RSRP of a semi-persistence SL CSI-RS sent to the first SL UE by the second SL UE is lower than a fifth RSRP threshold.

8. The method according to claim 1, wherein the second SL UE identifies the new candidate beam of the first SL UE by the following procedure:
when the first SL UE transmits a plurality of signals with different beam directions to the second SL UE, the second SL UE measures the signals and identifies the new candidate beam corresponding to one of the signals having a particular beam direction with best RSRP.

9. The method according to claim 1, wherein the second SL UE identifies the new candidate beam of the first SL UE by at least one of the following procedures:
when the first SL UE transmits a plurality of SL CSI-RS resources with different beam directions to the second SL UE, the second SL UE measures the SL CSI-RS resources and identifies the new candidate beam corresponding to one of the SL CSI-RS resource with best RSRP;
when the first SL UE transmits a plurality of S-SSB carrying a UE identifier of the first SL UE to the second SL UE, the second SL UE measures the plurality of S-SSB and identifies the new candidate beam corresponding to one of the S-SSB with best RSRP.

10. The method according to claim 1, wherein the second SL UE identifies the new candidate beam of the first SL UE by the following procedures:
the first SL UE triggers a beam pairing procedure, comprising:
the first SL UE transmits beam measuring reference resources or beam measuring reference signals with beam sweeping;
the second SL UE measures the beam measuring reference resources or the beam measuring reference signals sent from the first SL UE and identifies the new candidate beam corresponding to one of the beam measuring reference resources with best RSRP or one of the beam measuring reference signals with best RSRP.

11. A sidelink (SL) user equipment (UE) for performing beam failure recovery, comprising:
a communication module; and
a processing unit, for controlling the communication module, configured to perform the following procedures:
detecting beam failure instances; and
triggering a beam failure recovery procedure when a number of the beam failure instances is equal or larger than an instance threshold;
wherein under the beam failure recovery procedure, a peer SL UE identifies a new candidate beam;
wherein under the beam failure recovery procedure, the peer SL UE reports the new candidate beam and a UE identifier of the peer SL UE to the SL UE;
wherein under the beam failure recovery procedure, the peer SL UE monitors a response from the SL UE.

12. The SL UE according to claim 11, wherein when the SL UE receives a HARQ-NACK signal from the peer SL UE, the number of the beam failure instances is increased;
wherein when a measured RSRP of a SL CSI-RS is lower than a RSRP threshold, the number of the beam failure instances is increased.

13. The SL UE according to claim 11, wherein the SL UE triggers a beam pairing procedure toward the peer SL UE when the beam failure recovery procedure is triggered, and the peer SL UE identifies the new candidate beam of the SL UE under the beam pairing procedure.

14. The SL UE according to claim 11, wherein the peer SL UE reports the new candidate beam and the UE identifier of the peer SL UE to the SL UE through a SCI signal, the number of the beam failure instances is calculated by a MAC layer of the SL UE, and the beam failure recovery procedure is triggered by the MAC layer of the SL UE.

15. The SL UE according to claim 11, wherein the SL UE sends the response to the peer SL UE on a PSFCH corresponding to a PSCCH or a PSSCH of the peer SL UE.

16. The SL UE according to claim 11, wherein the number of the beam failure instances is increased when at least one of the following conditions is met:
the SL UE receives a HARQ-NACK from the peer SL UE after a PSCCH or a PSSCH is sent to the peer SL UE by the firs SL UE;
the SL UE receives no HARQ-ACK and no HARQ-NACK from the peer SL UE after the PSCCH or the PSSCH is sent to the peer SL UE by the firs SL UE during a monitoring window;
a first RSRP of a periodic SL CSI-RS sent to the SL UE by the peer SL UE is lower than a first RSRP threshold; and
a second RSRP of a S-SSB sent to the SL UE by the peer SL UE is lower than a second RSRP threshold when the S-SSB carries the UE identifier of the peer SL UE.

17. The SL UE according to claim 11, wherein the number of the beam failure instances is increased when at least one of the following conditions is met:
a third RSRP of a PSCCH or a PSSCH sent to the SL UE by the peer SL UE is lower than a third RSRP threshold;
a BLER of the PSCCH or PSSCH sent to the SL UE by the peer SL UE is higher than a BLER threshold;
a fourth RSRP of an aperiodic SL CSI-RS sent to the SL UE by the peer SL UE is lower than a fourth RSRP threshold; and
a fifth RSRP of a semi-persistence SL CSI-RS sent to the SL UE by the peer SL UE is lower than a fifth RSRP threshold.

18. The SL UE according to claim 11, wherein the peer SL UE identifies
the new candidate beam of the SL UE by the following procedure:
when the SL UE transmits a plurality of signals with different beam directions to the peer SL UE, the peer SL UE measures the signals and identifies the new candidate beam corresponding to one of the signals having a particular beam direction with best RSRP.

19. The SL UE according to claim 11, wherein the peer SL UE identifies the new candidate beam of the SL UE by at least one of the following procedures:
when the SL UE transmits a plurality of SL CSI-RS resources with different beam directions to the peer SL UE, the peer SL UE measures the SL CSI-RS resources and identifies the new candidate beam corresponding to one of the SL CSI-RS resource with best RSRP;
when the SL UE transmits a plurality of S-SSB carrying a UE identifier of the SL UE to the peer SL UE, the peer SL UE measures the plurality of S-SSB and identifies the new candidate beam corresponding to one of the S-SSB with best RSRP.

20. The SL UE according to claim 11, wherein the peer SL UE identifies the new candidate beam of the SL UE by the following procedures:
the SL UE triggers a beam pairing procedure, comprising:
the SL UE transmits beam measuring reference resources or beam measuring reference signals with beam sweeping;
the peer SL UE measures the beam measuring reference resources or the beam measuring reference signals sent from the SL UE and identifies the new candidate beam corresponding to one of the beam measuring reference resources with best RSRP or one of the beam measuring reference signals with best RSRP.
